(19) United States
(12) Patent Application Publication
(10) Pub. No.: US 2017/0138469 A1
(43) Pub. Date: May 18, 2017

(54) AUTOMATIC CALIBRATION OF POSITION THRESHOLDS FOR A GEAR SHIFT POSITION SENSOR

(71) Applicant: Parker Hannifin Corporation, Cleveland, OH (US)

(72) Inventors: Pradeep Gillella, Dublin, OH (US); Yisheng Zhang, Dublin, OH (US)

(21) Appl. No.: 15/299,954

(22) Filed: Oct. 21, 2016

Related U.S. Application Data
(60) Provisional application No. 62/255,561, filed on Nov. 16, 2015.

(51) Int. Cl. F16H 61/04; F16H 61/02

(52) U.S. Cl. CPC F16H 61/0403; F16H 61/0204; F16H 2061/0068

(57) ABSTRACT

A method for updating shift position thresholds for a multi-speed transmission is provided. The multi-speed transmission includes an input member for connection to a prime mover and an output member, the output member selectively couplable to the input member via a plurality of gear ratios, and a position sensor for providing data indicative of a position of a shift actuator for selecting between the plurality of gear ratios. The method includes: detecting a request to change the gear ratio between the input member and the output member; and subsequent to detecting the request to change the gear ratio, i) comparing a velocity of the output member to a prescribed velocity, ii) upon the velocity of the output member increasing and being less than the prescribed velocity, storing the position provided by the position sensor as a synchronization position, iii) upon the velocity of the output member corresponding to the prescribed value, storing the position provided by the position sensor as an endstop position, and iv) calculating a threshold position for the shift actuator based on the synchronization position and the endstop position.

### RELATED APPLICATION DATA

This application claims priority of U.S. Provisional Application No. 62/255,561 filed on Nov. 16, 2015, which is incorporated herein by reference in its entirety.

### TECHNICAL FIELD

The present disclosure relates generally to transmissions. More specifically, the present disclosure relates to a method and apparatus for automatically calibrating position thresholds for a gear shift position sensor of a transmission.

### BACKGROUND INFORMATION

In most conventional power transmission systems (e.g., automotive/industrial), a speed ratio between various components in the transmission is modified using a gear selector. In this regard, a position of the gear selector is varied using, for example, a hydraulic actuator. A linear position sensor is typically coupled to the gear selector to enable precise positioning of the gear selector at a number of discrete locations (e.g., 3 locations) to achieve various speed ratios (e.g., forward, neutral and reverse).

### SUMMARY OF THE INVENTION

Conventionally, the extreme ends of the gear selector movement are used for detecting the discrete positions of the gear selector and thus for determining linear position sensor thresholds. However, characterization of the linear position sensor thresholds are susceptible to variations in component dimensions. As a result, different thresholds may be required between transmissions of the same type. Further, mechanical wear and other environmental factors (e.g., contamination) can affect sensor output and thus introduce uncertainty in the position of the gear shift actuator. It is thus preferable to develop a more robust approach for characterizing the linear position of the position sensor.

In accordance with the present disclosure, an apparatus and method are provided that can overcome one or more of the above and/or other problems. More particularly, the apparatus and method in accordance with the present disclosure provide a more robust method for automatically characterizing a linear position sensor. In accordance with the present disclosure, a measured speed of the transmission components is utilized to identify various stages of the shift, and the thresholds are determined based on the speed changes. The approach is also setup to refine these values periodically during normal operation of the transmission

According to one aspect of the disclosure, a method for updating shift position thresholds for a multi-speed transmission is provided. The multi-speed transmission includes an input member for connection to a prime mover and an output member, the output member selectively couplable to the input member via a plurality of gear ratios, and a position sensor for providing data indicative of a position of a shift actuator for selecting between the plurality of gear ratios. The method includes: detecting a request to change the gear ratio between the input member and the output member; and subsequent to detecting the request to change the gear ratio, i) comparing a velocity of the output member to a prescribed velocity, ii) upon the velocity of the output member increasing and being less than the prescribed velocity, storing the position provided by the position sensor as a synchronization position, iii) upon the velocity of the output member corresponding to the prescribed value, storing the position provided by the position sensor as an endstop position, and iv) calculating a threshold position for the shift actuator based on the synchronization position and the endstop position.

In one embodiment, storing the synchronization position or the endstop position includes storing the respective positions based on a running average of the position sensor data over a prescribed time period.

In one embodiment, the prescribed time period is between 0.1 seconds and 2.0 seconds.

In one embodiment, upon the output member velocity being greater than or equal to the expected value or decreasing, de-energizing the shift actuator.

In one embodiment, upon detecting the request to change the change gear ratio further includes energizing the shift actuator.

According to another aspect of the disclosure, a controller is provided for changing a gear ratio of a multi-speed transmission having an input member for connection to a prime mover and an output member, the output member selectively couplable to the input member via a plurality of gear ratios, and a position sensor for providing data indicative of a position of a shift actuator for selecting between the plurality of gear ratios. The controller includes: a processor and memory operatively coupled to the processor; a shift threshold detection module store din memory and executable by the processor, the shift threshold module configured to cause the processor to detect a request to change the gear ratio between the input member and the output member; and subsequent to detecting the request to change the gear ratio, i) compare a velocity of the output member to a prescribed velocity, ii) upon the velocity of the output member increasing and being less than the prescribed velocity, store the position provided by the position sensor as a synchronization position, iii) upon the velocity of the output member corresponding to the prescribed value, store the position provided by the position sensor as an endstop position, and iv) calculate a threshold position for the shift actuator based on the synchronization position and the endstop position.

In one embodiment, the shift threshold detection module is configured to cause the processor to store the synchronization position or the endstop position based on a running average of the position sensor data over a prescribed time period.

In one embodiment, the prescribed time period is between 0.1 seconds and 2.0 seconds.

In one embodiment, the shift threshold detection module is configured to cause the processor to de-energize the shift actuator upon the output member velocity being greater than or equal to the expected value or decreasing.

In one embodiment, the shift threshold detection module is configured to cause the processor to energize the shift actuator upon detecting the request to change the change gear ratio.

According to another aspect of the present disclosure, a multi-speed transmission includes: a plurality of gears arranged relative to one another, the plurality of gears selectively couplable to one another to define a plurality of gear ratios; a shift actuator for selecting one of the plurality of gear ratios; a position sensor operatively coupled to the shift actuator and operative to provide data indicative of a position of the shift actuator; and the controller described herein operatively coupled to the shift actuator and the position sensor.

In one embodiment, the transmission includes an input member coupled to a first gear of the plurality of gears.

In one embodiment, the transmission includes an output member coupled to a second gear of the plurality of gears, the second gear different from the first gear.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Many aspects of the invention in accordance with the present disclosure can be better understood with reference to the following drawings. The components in the drawings are not necessarily to scale, emphasis instead being placed upon clearly illustrating the principles in accordance with the present disclosure. Likewise, elements and features depicted in one drawing may be combined with elements and features depicted in additional drawings. Additionally, in the drawings, like reference numerals designate corresponding parts throughout the several views.

FIG. 1 is a block diagram of a transmission to which principles in accordance with the present disclosure may be applied.

FIG. 2 is a graph illustrating shift invents in accordance with the present disclosure.

FIG. 3 is a flowchart illustrating steps for performing a method of characterizing a gear shift position sensor in accordance with the present disclosure.

### DETAILED DESCRIPTION

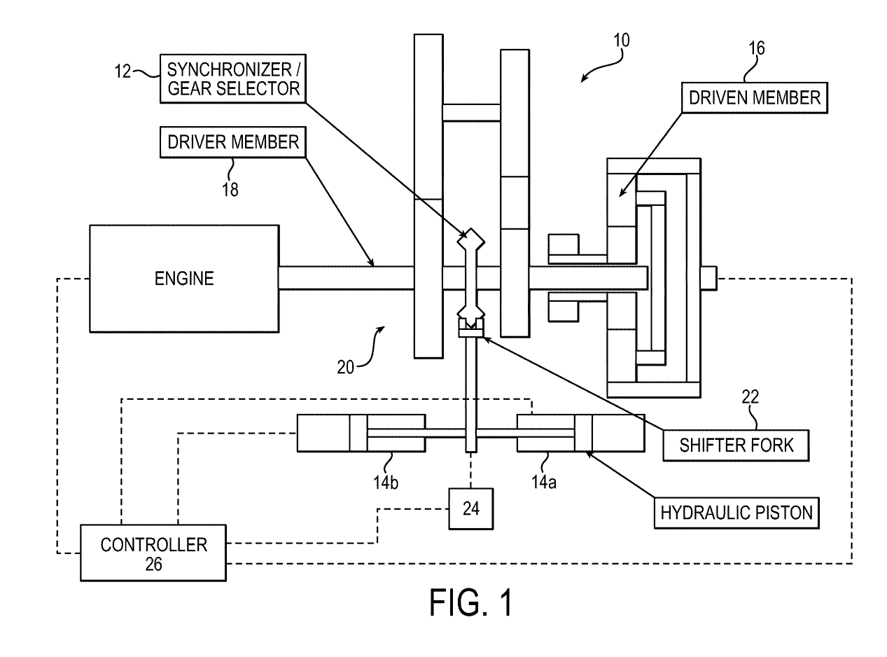

With reference to FIG. 1, illustrated is an exemplary transmission 10 to which principles in accordance with the present disclosure may be applied. The exemplary transmission 10 includes a synchronizer/gear selector assembly 12 that is actuated by two hydraulic pistons 14a, 14b to change the direction of rotation of the driven member 16 (e.g., an output member of the transmission) with respect to the driver member 18 (e.g., an input member of the transmission). In this regard, a plurality of gears 20 are selectively couplable between the driver member 18 and the driven member 16, wherein a gear ratio or forward/reverse direction between the driver member 18 and the driven member 16 is based on the particular gears that are coupled therebetween.

For normal operation, one of the hydraulic pistons 14a, 14b is pressurized based on the desired direction of travel, thereby moving the shifter fork 22 between 3 discrete positions (two end positions for engaging different gears and a middle position for disengaging the transmission). Once the shifter fork 22 has reached the desired location, the hydraulic pistons 14a, 14b are preferably de-pressurized.

Conventionally, a linear position sensor 24 has been used for closed loop position control for the shifter fork 22. Position thresholds are compared to data provided by the linear position sensor 24 to confirm a successful shift into either gear. These position thresholds, however, can vary from one transmission to another due to the variability in component dimensions that may result from manufacturing tolerances. The thresholds also can vary as a function of time due to mechanical wear of associated components

In accordance with the present disclosure, an automated procedure is implemented for the sensor characterization with the intent of establishing and periodically updating the shift position thresholds over the life of the transmission 10.

The thresholds should be robust to ensure that either sensor electrical noise or minor movements of the shifter while the gear is still engaged do not cause unnecessary activation of the shifter actuators. The extreme ends of the shifter fork movement are not used as the thresholds since they do not necessarily confirm a successful engagement of the gears. Therefore, in accordance with the present disclosure the speeds of various rotating members of the transmission 10 are relied upon to classify the shifter movement into various stages. The various stages then are used to calculate the shift position thresholds.

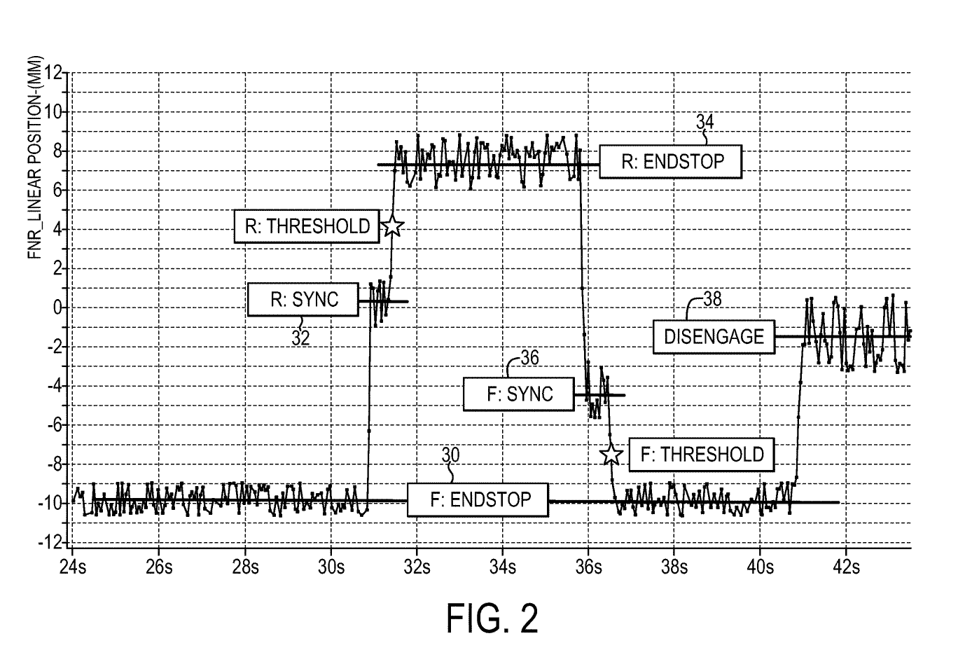

With reference to FIG. 2, illustrated is a graph of the various events that may occur during a gear change in a transmission 10. These events include a forward endstop 30, a reverse sync 32, a reverse endstop 34, a forward sync 36, and a disengage (neutral) 38. In one embodiment, the threshold is calculated as the midpoint of the “sync” and “endstop” positions, where sync is the position of the shifter where the synchronizer is increasing the speed of driven member, and the endstop is the position of the shifter after the actuator is de-energized and the speed of the driven member still matches up with the value expected based on the driver member and the gear-ratios. In other embodiments, the threshold may be calculated as being closer to the sync position or closer to the endstop position.

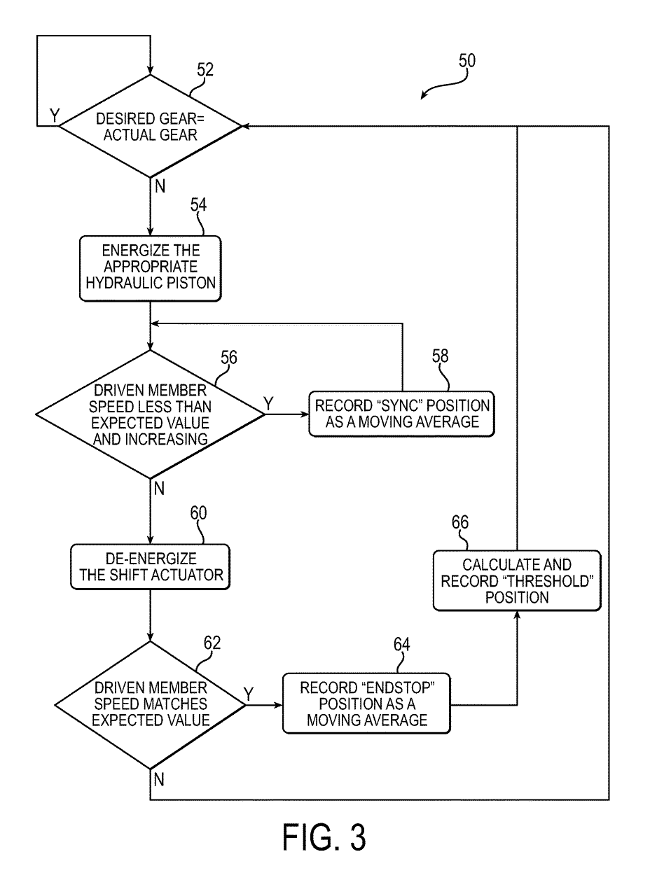

FIG. 3 illustrates an exemplary method 50 for carrying out calibration of the shift thresholds in accordance with the present disclosure. The method 50 may be executed, for example, by a controller 26 (see FIG. 1) of the transmission, the controller including a processor and memory or other circuitry configured to carry out the steps of the method. The memory or other circuitry may include a shift threshold module configured to execute the method described herein.

Beginning at step 52, the controller determines if the transmission is in the desired gear. Such determination may be based, for example, on a position of the gear shift lever, which may be provided as an input to the controller. If the transmission is in the desired gear, the method loops at step 52. If the transmission is not in the desired gear, then the method moves to step 54 where the appropriate actuator is energized (e.g., hydraulic actuators 14a or 14b). Next at step 56 the velocity of the driven (output) member 16 is compared to a prescribed velocity. The prescribed velocity may be calculated/updated by the controller based on known data. Such data may include, for example, a speed of the driver (input) member 18 and/or prime mover, and a speed of the device coupled to the driven member 16. Upon the velocity of the driven member 16 increasing and being less than the prescribed velocity, the method moves to step 58 where the controller stores the position provided by the position sensor 24 as a synchronization position. The synchronization positon may be an average of the data collected over a specified time period. For example, the synchronization position may be based on a running average of the position sensor data over the prescribed time period (e.g., 0.1 to 2 seconds). The method then moves back to step 56 and continues.

At step 56, if the speed is not increasing or is not less than the prescribed velocity, the method moves to step 60 where the controller de-energizes the actuator (hydraulic pistons 14a, 14b). The method then moves to step 62 where the controller compares the velocity of the driven member 16 to the prescribed velocity.

If the velocity of the driven member 16 does not correspond to the prescribed value (e.g., the same velocity or within a prescribed value of one another), the controller aborts the current calibration and moves back to step 52 and repeats. However, if the controller determines the velocity of the driven member 16 corresponds to the prescribed value (e.g., the same velocity or within a prescribed value of one another), then at step 64 the controller stores the position provided by the position sensor as an endstop position. Again, such positon may be based on an average of the data collected over a specified time period. Next at step 66 the controller calculates the threshold position based on the synchronization position and the endstop position. For example, the threshold positon may be calculated as the midpoint between the endstop position and the synchronization position. The method then moves back to step 52 and repeats.

Although the principles, embodiments and operation of the present invention have been described in detail herein, this is not to be construed as being limited to the particular illustrative forms disclosed. For example, the illustrated mechanical gear set could alternatively include a planetary mechanical gear set. Also, the illustrated hybrid mechanism could alternatively include electric motors and generators and batteries and the operation of the vehicle body power equipment could be assisted by stored electrical energy. It will thus become apparent to those skilled in the art that various modifications of the embodiments herein can be made without departing from the spirit or scope of the invention.

1. A method for updating shift position thresholds for a multi-speed transmission having an input member for connection to a prime mover and an output member, the output member selectively couplable to the input member via a plurality of gear ratios, and a position sensor for providing data indicative of a position of a shift actuator for selecting between the plurality of gear ratios, the method comprising:
detecting a request to change the gear ratio between the input member and the output member; and
subsequent to detecting the request to change the gear ratio,
i) comparing a velocity of the output member to a prescribed velocity,
ii) upon the velocity of the output member increasing and being less than the prescribed velocity, storing the position provided by the position sensor as a synchronization position,
iii) upon the velocity of the output member corresponding to the prescribed value, storing the position provided by the position sensor as an endstop position, and
iv) calculating a threshold position for the shift actuator based on the synchronization position and the endstop position.

2. The method according to claim 1, wherein storing the synchronization position or the endstop position includes storing the respective positions based on a running average of the position sensor data over a prescribed time period.

3. The method according to claim 2, wherein the prescribed time period is between 0.1 seconds and 2.0 seconds.

4. The method according to claim 1, wherein upon the output member velocity being greater than or equal to the expected value or decreasing, de-energizing the shift actuator.

5. The method according to claim 1, wherein upon detecting the request to change the change gear ratio further includes energizing the shift actuator.

6. A method for updating shift position thresholds for a multi-speed transmission having an input member for connection to a prime mover and an output member, the output member selectively couplable to the input member via a plurality of gear ratios, and a position sensor for providing data indicative of a position of a shift actuator for selecting between the plurality of gear ratios, the method comprising calculating the shift position threshold based on changes in speed between the output member relative to the input member.

7. A controller for changing a gear ratio of a multi-speed transmission having an input member for connection to a prime mover and an output member, the output member selectively couplable to the input member via a plurality of gear ratios, and a position sensor for providing data indicative of a position of a shift actuator for selecting between the plurality of gear ratios, the controller comprising:
a processor and memory operatively coupled to the processor;
a shift threshold detection module store din memory and executable by the processor, the shift threshold module configured to cause the processor to
detect a request to change the gear ratio between the input member and the output member; and
subsequent to detecting the request to change the gear ratio,
i) compare a velocity of the output member to a prescribed velocity,
ii) upon the velocity of the output member increasing and being less than the prescribed velocity, store the position provided by the position sensor as a synchronization position,
iii) upon the velocity of the output member corresponding to the prescribed value, store the position provided by the position sensor as an endstop position, and
iv) calculate a threshold position for the shift actuator based on the synchronization position and the endstop position.

8. The controller according to claim 7, wherein the shift threshold detection module is configured to cause the processor to store the synchronization position or the endstop position based on a running average of the position sensor data over a prescribed time period.

9. The controller according to claim 8, wherein the prescribed time period is between 0.1 seconds and 2.0 seconds.

10. The controller according to claim 7, wherein the shift threshold detection module is configured to cause the processor to de-energize the shift actuator upon the output member velocity being greater than or equal to the expected value or decreasing.

11. The controller according to claim 7, wherein the shift threshold detection module is configured to cause the processor to energize the shift actuator upon detecting the request to change the change gear ratio.

12. A multi-speed transmission, comprising:
a plurality of gears arranged relative to one another, the plurality of gears selectively couplable to one another to define a plurality of gear ratios;
a shift actuator for selecting one of the plurality of gear ratios;
a position sensor operatively coupled to the shift actuator and operative to provide data indicative of a position of the shift actuator; and
the controller according to claim 6 operatively coupled to the shift actuator and the position sensor.

13. The transmission according to claim 12, further comprising an input member coupled to a first gear of the plurality of gears.

14. The transmission according to claim 13, further comprising an output member coupled to a second gear of the plurality of gears, the second gear different from the first gear.
